(19) United States
(12) Patent Application Publication
(10) Pub. No.: US 2011/0007007 A1
(43) Pub. Date: Jan. 13, 2011

(54) TOUCH CONTROL METHOD

(75) Inventors: Wei-Te Lin, Tu-Cheng (TW); Te-Hua Lee, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/755,375

(22) Filed: Apr. 6, 2010

(30) Foreign Application Priority Data
Jul. 13, 2009 (CN) 200910304296.5

(51) Int. Cl. G06F 3/041

(52) U.S. Cl. 345/173

(57) ABSTRACT

An exemplary touch control method includes, first, obtaining a to-be-operated object according to a user's operation. A second step is detecting coordinates A(X_{A}, Y_{A}) of a first touch point. A third step is detecting coordinates B(X_{B}, Y_{B}) of an initial point of a second touch point. A fourth step is obtaining an operating center C(X_{C}, Y_{C}) according to the coordinates A(X_{A}, Y_{A}) and B(X_{B}, Y_{B}). A fifth step is detecting coordinates B′(X_{B′}, Y_{B′}) of the second touch point after the second touch point is moved. A sixth step is computing an angle α between two vectors CB and CB′ according to the coordinates C(X_{C}, Y_{C}) and B(X_{B}, Y_{B}). A seventh step is rotating the to-be-operated object by the angle α around the operating center C(X_{C}, Y_{C}).

### BACKGROUND

1. Technical Field

The present disclosure relates to touch screens, and particularly to a touch control method for operating touch screens.

2. Description of Related Art

Touch screens are widely used in electronic devices to act as input and output devices. In order to rotate a selected object displayed by the electronic device, a user commonly uses a cursor to “click on” an icon displayed on the touch screen, or touches the icon with his or her fingertip or a stylus.

However, the need to rotate the selected object by way of manual clicking or touching is somewhat inconvenient. Therefore, improved touch control methods are desired.

### BRIEF DESCRIPTION OF THE DRAWINGS

Many aspects of various embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a touch screen on which a coordinate system is defined in accordance with an exemplary embodiment.

FIG. 2 is a flow chart of a touch control method in accordance with an exemplary embodiment.

### DETAILED DESCRIPTION

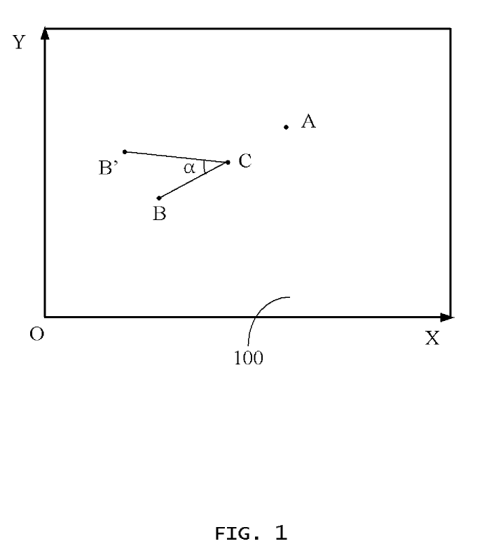

A touch screen can be operable to detect positions of touch inputs on the touch screen. The touch screen may detect the touch inputs using any of a variety of touch sensing technologies, including, but not limited to capacitive, resistive, infrared, and surface acoustic wave technologies. Referring to FIG. 1, for the sake of simplicity and easier understanding, a rectangular touch screen 100 is illustrated. A Cartesian (rectangular) coordinate system is defined on the touch screen 100. An origin O of the coordinate system is defined at one corner of the touch screen 100. An X-axis and a Y-axis of the coordinate system extend along two edges connected to the origin O, respectively. As such, each point of the touch screen has fixed coordinates.

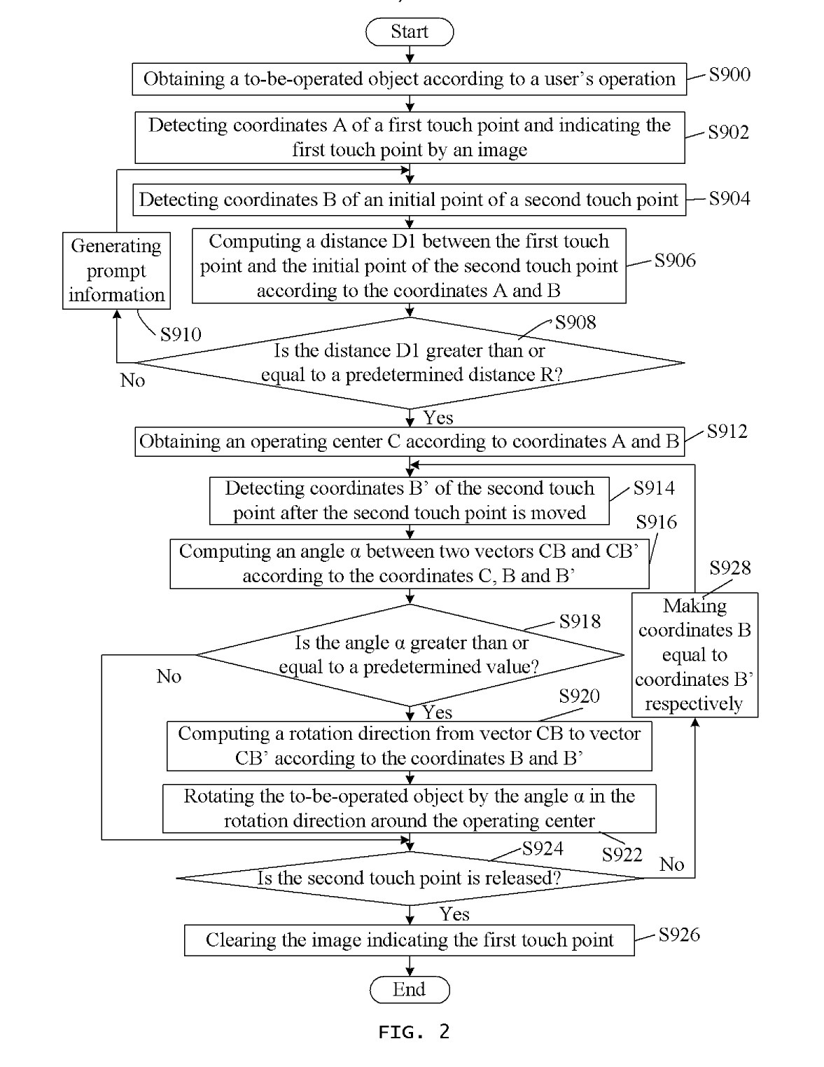

Referring also to FIG. 2, a touch control method, is provided. The method is based on touch position detecting technology used in the touch screen 100 described above. The touch control method can enhance flexibility of use for a person (user) who operates the touch screen 100. The touch control method includes the following steps.

Step S900 is obtaining a to-be-operated object according to a user's operation. In detail, if the user selects an area or an object displayed on the touch screen 100, the selected area or the selected object is the to-be-operated object. If the user does not select any area or object displayed on the touch screen 100, all objects displayed on the touch screen 100 are the to-be-operated object. In the present embodiment, the to-be-operated object may be an image or an icon displayed on the touch screen 10.

Step S902 is detecting coordinates A(X_{A}, Y_{A}) of a first touch point. The first touch point is a fixed point. In the present embodiment, the first touch point is obtained by means of double clicking. That is, when the user double clicks the same point in a first predetermined period, the double clicked point is used as the first touch point. The first predetermined period may be 1 second. To be easily operated by the user, the first touch point is indicated by an image, such as a red dot, displayed on the touch screen 100.

Step S904 is detecting coordinates B(X_{B}, Y_{B}) of an initial point of a second touch point. The second touch point is a moving point. That is, the second touch point traces a line. Touching the touch screen 100 and dragging such touch along the touch screen 100 can obtain the second touch point. In the present embodiment, in a second predetermined period after the first touch point is obtained, if the user touches the touch screen 100 again, the touched point is used as the initial point of the second touch point. The second predetermined period may be 1 second.

Step S906 is computing a distance D1 between the first touch point and the initial point of the second touch point according to the coordinates A(X_{A}, Y_{A}) and B(X_{B}, Y_{B}). In the present embodiment, the distance D1 can be computed according to the following equation (1):

D1=\sqrt{(X_{B}−X_{A})²+(Y_{B}−Y_{A})²}. (1).

Step S908 is determining whether the distance D1 is greater than or equal to a predetermined distance R. If the distance D1 is greater than or equal to the predetermined distance R, step S912 is implemented. If the distance D1 is less than the predetermined distance R, step S910 is implemented.

Step S910 is generating prompt information to remind the user that the initial point of the second touch point is invalid, and allowing the user to input the initial point of the second touch point again, whereupon step S904 is again implemented. The prompt information may be image information, audio information, etc.

Step S912 is obtaining an operating center C(X_{C}, Y_{C}) according to the coordinates A(X_{A}, Y_{A}) and B(X_{B}, Y_{B}). The operating center C(X_{C}, Y_{C}) can be computed using a predetermined formula according to requirements of the user. In the present embodiment, the operating center C(X_{C}, Y_{C}) may be a middle point of a line segment between the first touch point and the initial point of the second touch point, and the predetermined formula may be X_{C}=(X_{A}+X_{B})/2,Y_{C}=(Y_{A}+Y_{B})/2. In other embodiments, the operating center C(X_{C}, Y_{C}) may only be computed according to the coordinates A(X_{A}, Y_{A}) of the first touch point. For example, the operating center C(X_{C}, Y_{C}) may be the first touch point, so that the predetermined formula is X_{C}=X_{A}, Y_{C}=Y_{A}.

Step S914 is detecting the coordinates B′ (X_{B′}, Y_{B′}) of the second touch point after the second touch point is moved.

Step S916 is computing an angle α between two vectors CB and CB′ according to the coordinates C(X_{C}, Y_{C}), B(X_{B}, Y_{B}), and B′(X_{B′}, Y_{B′}). In the present embodiment, the angle α can be computed according to the following equation (2):

$$α = {COS}^{- 1} ( \frac{\begin{matrix}( {X}_{{B}^{′}} - {X}_{C} ) * ( {X}_{B} - {X}_{C} ) + \\ ( {Y}_{{B}^{′}} - {Y}_{C} ) * ( {Y}_{B} - {Y}_{C} )\end{matrix}}{\begin{matrix}\sqrt{{( {X}_{B} - {X}_{C} )}^{2} + {( {Y}_{B} - {Y}_{C} )}^{2}} * \\ \sqrt{{( {X}_{{B}^{′}} - {X}_{C} )}^{2} + {( {Y}_{{B}^{′}} - {Y}_{C} )}^{2}}\end{matrix}} ) . \qquad ( 2 )$$

Step S918 is determining whether the angle α is greater than or equal to a predetermined value. If the angle α is greater than or equal to the predetermined value, step S920 is implemented. If the angle α is less than the predetermined value, step S924 is implemented. In the present embodiment, the predetermined value is 2 degrees.

Step S920 is computing a rotation direction from the vector CB to the vector CB′ according to the coordinates B(X_{B′}, Y_{B}) and B′(X_{B′}, Y_{B′}). In the present embodiment, the rotation direction is determined via comparing the values of Y_{B} and Y_{B′}. If Y_{B′} is greater than Y_{B}, the rotation direction is clockwise. If Y_{B′} is less than Y_{B}, the rotation direction is counterclockwise. If Y_{B′} is equal to Y_{B}, the rotation direction is determined via comparing the values of X_{B′} and X_{B}. If X_{B′} is greater than X_{B}, the rotation direction is counterclockwise. If X_{B′} is less than X_{B}, the rotation direction is clockwise.

Step S922 is rotating the to-be-operated object by the angle α in the rotation direction around the operating center C(X_{C}, Y_{C}).

Step S924 is determining whether the second touch point is released. If the second touch point is released, step S926 is implemented. If the second touch point is not released, step S928 is implemented.

Step S926 is clearing the image indicating the first touch point.

Step S928 is making the coordinates B(X_{B}, Y_{B}) equal to the coordinates B′ (X_{B′}, Y_{B′}) respectively, that is, making Y_{B}=T_{B′}, and X_{B}=X_{B′}. Thereupon, step S914 is again implemented.

Using the touch control method, the to-be-operated object rotates in real-time according to a movement path of the second touch point. Thus rotations of the to-be-operated object can be performed intuitively by a novice user, and the rotations provide more flexibility for a user's operations.

In a further embodiment, to enable easy operation by a user, the movement path of the second touch point also can be indicated by an image. In such case, the image indicating the second touch point is cleared when the second touch point is released.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A touch control method for operating a touch screen, the touch control method comprising:
obtaining a to-be-operated object according to a user's operation;
detecting coordinates A(X_{A}, Y_{A}) of a first touch point with respect to to-be-operated object on the touch screen;
detecting coordinates B(X_{B}, Y_{B}) of an initial point of a second touch point;
obtaining an operating center C(X_{C}, Y_{C}) according to the coordinates A(X_{A}, Y_{A}) and B(X_{B}, Y_{B});
detecting coordinates B′(X_{B′}, Y_{B′}) of the second touch point after the second touch point is moved;
computing an angle α between two vectors CB and CB′ according to the coordinates C(X_{C}, Y_{C}), B(X_{B}, Y_{B}); and
rotating the to-be-operated object by the angle α around the operating center C(X_{C}, Y_{C}).

2. The touch control method according to claim 1, further comprising:
computing a rotation direction from the vector CB to the vector CB′ according to the coordinates B(X_{B}, Y_{B}) and B′(X_{B′}, Y_{B′}); and
rotating the to-be-operated object by the angle α in the rotation direction around the operating center C(X_{C}, Y_{C}).

3. The touch control method according to claim 2, wherein the rotation direction is firstly obtained via comparing the values of Y_{B} and Y_{B′}; and if Y_{B′} is greater than Y_{B}, the rotation direction is clockwise; if Y_{B′} is less than Y_{B}, the rotation direction is counterclockwise; and if Y_{B′} is equal to Y_{B}, the rotation direction is obtained via comparing the values of X_{B′} and X_{B}; and if X_{B′} is greater than X_{B}, the rotation direction is counterclockwise; and if X_{B′} is less than X_{B}, the rotation direction is clockwise.

4. The touch control method according to claim 1, further comprising:
determining whether the angle α is greater than or equal to a predetermined value; and
if the angle α is greater than or equal to the predetermined value, rotating the to-be-operated object by the angle α around the operating center C(X_{C}, Y_{C}).

5. The touch control method according to claim 1, further comprising:
computing a distance D1 between the first touch point and the initial point of the second touch point according to the coordinates A(X_{A}, Y_{A}) and B(X_{B}, Y_{B});
determining whether the distance D1 is greater than or equal to a predetermined distance R; and
if the distance D1 is greater than or equal to the predetermined distance R, repeating obtaining an operating center C(X_{C}, Y_{C}) according to the coordinates A(X_{A}, Y_{A}) and B(X_{B}, Y_{B}).

6. The touch control method according to claim 5, further comprising:
if the distance D1 is less than the predetermined distance R, generating prompt information to remind the user that the initial point of the second touch point is invalid, thereby allowing the user to input the initial point of the second touch point again, and repeating detecting coordinates B(X_{B}, Y_{B}) of an initial point of a second touch point.

7. The touch control method according to claim 1, further comprising:
determining whether the second touch point is released; and
if the second touch point is not released, making the coordinates B(X_{B′}, Y_{B′}) equal to coordinates B′(X_{B′}, Y_{B′}), and repeating detecting coordinates B′(X_{B′}, Y_{B′}) of the second touch point after the second touch point is moved.

8. The touch control method according to claim 7, further comprising:
indicating the first touch point by an image when coordinates A(X_{A}, Y_{A}) of the first touch point are detected; and
clearing the image indicating the first touch point if the second touch point is released.

9. The touch control method according to claim 7, further comprising:
indicating a movement path of the second touch point by an image; and
clearing the image indicating the movement path of the second touch point if the second touch point is released.

10. The touch control method according to claim 1, wherein the operating center C(X_{C}, Y_{C}) is a middle point of a line segment between the first touch point and the initial point of the second touch point, such that X_{C}=(X_{A}+X_{B})/2, and Y_{C}=(Y_{A}±Y_{B})/2.

11. A touch control method, comprising:
obtaining a to-be-operated object according to a user's operation;
detecting coordinates A(X_{A}, Y_{A}) of a first touch point;
detecting coordinates B(X_{B}, Y_{B}) of an initial point of a second touch point;
obtaining an operating center C(X_{C}, Y_{C}) according to the coordinates A(X_{A}, Y_{A});
detecting coordinates B′(X_{B′}, Y_{B′}) of the second touch point after the second touch point is moved;
computing an angle α between two vectors CB and CB′ according to the coordinates C(X_{C}, Y_{C}) and B(X_{B}, Y_{B}); and
rotating the to-be-operated object by the angle α around the operating center C(X_{C}, Y_{C}).

12. The touch control method according to claim 11, further comprising:
computing a rotation direction from the vector CB to the vector CB′ according to the coordinates B(X_{B}, Y_{B}) and B′(X_{B′}, Y_{B′}); and
rotating the to-be-operated object the angle α in the rotation direction around the operating center C(X_{C}, Y_{C}).

13. The touch control method according to claim 12, wherein the rotation direction is firstly obtained via comparing the values of Y_{B} and Y_{B′}; and if Y_{B′} is greater than Y_{B}, the rotation direction is clockwise; if Y_{B′} is less than Y_{B}, the rotation direction is counterclockwise; and if Y_{B′} is equal to Y_{B}, the rotation direction is obtained via comparing the values of X_{B′} and X_{B}; and if X_{B′} is greater than X_{B}, the rotation direction is counterclockwise; and if X_{B′} is less than X_{B}, the rotation direction is clockwise.

14. The touch control method according to claim 11, further comprising:
determining whether the angle α is greater than or equal to a predetermined value; and
if the angle α is greater than or equal to the predetermined value, rotating the to-be-operated object the angle α around the operating center C(X_{C}, Y_{C}).

15. The touch control method according to claim 11, further comprising:
computing a distance D1 between the first touch point and the initial point of the second touch point according to the coordinates A(X_{A}, Y_{A}) and B(X_{B}, Y_{B});
determining whether the distance D1 is greater than or equal to a predetermined distance R; and
if the distance D1 is greater than or equal to the predetermined distance R, repeating obtaining an operating center C(X_{C}, Y_{C}) according to the coordinates A(X_{A}, Y_{A}).

16. The touch control method according to claim 15, further comprising:
if the distance D1 is less than the predetermined distance R, generating prompt information to remind the user that the initial point of the second touch point is invalid, thereby allowing the user to input the initial point of the second touch point again, and repeating detecting coordinates B(X_{B}, Y_{B}) of an initial point of a second touch point.

17. The touch control method according to claim 11, further comprising:
determining whether the second touch point is released; and
if the second touch point is not released, making the coordinates B(X_{B}, Y_{B}) equal to coordinates B′(X_{B′}, Y_{B′}), and repeating detecting coordinates B′(X_{B′}, Y_{B′}) of the second touch point after the second touch point is moved.

18. The touch control method according to claim 17, further comprising:
indicating the first touch point by an image when coordinates A(X_{A}, Y_{A}) of the first touch point are detected; and
clearing the image indicating the first touch point if the second touch point is released.

19. The touch control method according to claim 17, further comprising:
indicating a movement path of the second touch point by an image; and
clearing the image indicating the movement path of the second touch point if the second touch point is released.

20. The touch control method according to claim 11, wherein the operating center C(X_{C}, Y_{C}) is the first touch point, such that X_{C}=X_{A}, and Y_{C}=Y_{A}.
